(19) United States
(12) Patent Application Publication
(10) Pub. No.: US 2025/0246746 A1
(43) Pub. Date: Jul. 31, 2025

(54) CELL SEPARATING ELEMENT, BATTERY MODULE, BATTERY FOR A MOTOR VEHICLE AND METHOD FOR PRODUCING A CELL SEPARATING ELEMENT WITH IMPROVED FIRE PROTECTION AND ADAPTATION PROPERTIES

(71) Applicant: AUDI AG, Ingolstadt (DE)

(72) Inventor: Julius RAUSCH, Heilbronn (DE)

(73) Assignee: AUDI AG, Ingolstadt (DE)

(21) Appl. No.: 18/983,774

(22) Filed: Dec. 17, 2024

(30) Foreign Application Priority Data
Jan. 31, 2024 (DE) 102024102803.3

(51) Int. Cl. H01M 50/293; B60R 16/033; H01M 50/209; H01M 50/342

(52) U.S. Cl. CPC H01M 50/293; H01M 50/209; H01M 50/3425; B60R 16/033; H01M 2220/20

(57) ABSTRACT

A cell separating element for arrangement between two battery cells of a battery module including at least one elastically compressible foam layer which have a polymeric material. The cell separating element has two outer sides which are opposite one another with respect to a first direction and the spacing of which in the first direction defines a thickness of the cell separating element, and the cell separating element has a first edge region which delimits the cell separating element with respect to a second direction. The thickness of the cell separating element is greater in the first edge region than in a central region of the cell separating element.

### FIELD

The invention relates to a cell separating element for arrangement between two battery cells of a battery module, wherein the cell separating element comprises at least one elastically compressible foam layer comprising a polymeric material, wherein the cell separating element has two outer sides opposite one another with respect to a first direction, the spacing of which in the first direction defines a thickness of the cell separating element, and wherein the cell separating element has a first edge region which delimits the cell separating element with respect to a second direction. Furthermore, the invention also relates to a battery module, a battery and a method for producing a cell separating element.

### BACKGROUND

Cell separating elements are often provided as flat, i.e. two-dimensional, planar, e.g. plate-shaped elements, which are arranged between battery cells. These act as spacers in the cell stack between the battery cells. Such cell separating elements can take on various technical functions in such a battery module, especially in a high-voltage module. On the one hand, this can provide thermal decoupling of the adjacent battery cells through a correspondingly low thermal conductivity of the cell separating elements during operation. In addition, they can provide a certain degree of protection against burnout of neighboring cells in the event of a malfunction. Cell separating elements can therefore serve to protect against fire and to provide thermal insulation for the neighboring cell adjacent to the thermally runaway battery cell. In addition, they can also absorb mechanical forces and deformations caused by the change in thickness of the battery cells during operation and/or over their service life in the vehicle; this change in thickness is also referred to as swelling. Therefore, a certain compressibility of the cell separating elements is advantageous. Various embodiments of cell separating elements are known from the prior art, for example as cushions with ceramic or mineral fibers, foams, composite materials or the like.

DE 10 2023 100 341 A1 describes a battery system with two battery modules and a thermally resistant spacer consisting of thermally resistant additives and arranged between the two battery modules, wherein the thermally resistant spacer comprises a thermally resistant urethane foam or a silicone cushion. The thermally resistant spacer can in particular comprise a central layer, which in turn comprises the thermally resistant urethane foam or the silicone cushion, which is arranged between at least a first high-temperature glass fabric and a second high-temperature glass fabric. Furthermore, the battery system may comprise at least one flame retardant material arranged on at least one outer surface of the thermally resistant spacer, wherein the flame retardant material may be a basalt fabric or a glass mat or an alumina fiber fabric or a calcium silicate fabric.

US 2023/0253673 A1 describes a battery with improved fire properties. For this purpose, an element is used to reduce the spread of fire. The element may comprise two flexible outer layers of graphite and a foam core.

### SUMMARY

The object of the present invention is to provide a cell separating element, a battery module, a battery and a method which enable the provision of a cell separating element with the best possible fire protection properties and/or adaptation properties.

A cell separating element according to the invention for arrangement between two battery cells of a battery module, comprises at least one elastically compressible foam layer comprising a polymeric material, wherein the cell separating element has two outer sides opposite one another with respect to a first direction, the spacing of which in the first direction defines a thickness of the cell separating element, and wherein the cell separating element has a first edge region which delimits the cell separating element with respect to a second direction. The thickness of the cell separating element is greater in the first edge region than in a central region of the cell separating element.

The invention is based on several findings: Firstly, battery cells are often geometrically designed in such a way that they have rounded corners and edges. Such a rounding of the edges means that the space between two such battery cells arranged next to each other widens in this rounding region. Because the cell separating element is designed such that a thickness in the first edge region is greater than in a central region of the cell separating element, this cell separating element is geometrically better adapted to such battery cells and thus advantageously allows, on the one hand, improved support of the battery cells relative to one another. In addition, this allows above all for improved sealing between the battery cells with regard to gas escaping from a battery cell in the event of thermal runaway. This configuration advantageously makes it possible to improve the shielding effect of the cell separating element with regard to thermal runaway of a battery cell with respect to a neighboring cell. The neighboring cell of such a thermally runway battery cell is therefore much better protected by such a cell separating element and thermal propagation can thus be counteracted much more efficiently. Even if the battery cells are not designed with rounded edges, the widened design of the cell separating element in the first edge region can ensure that the cell separating element located between the two battery cells can provide an increased sealing effect, especially in the edge region, due to the increased contact pressure caused by the widened design. In the event of thermal runaway of a battery cell, the penetration of gas escaping from this cell into the inter-cell region between two such battery cells can thus be prevented just as efficiently. This also provides better protection for the neighboring cell. Furthermore, the invention is based on the knowledge that there are manufacturing processes, such as injection molding processes or extrusion processes, by means of which an elastically compressible foam layer can be produced using a polymeric material with a three-dimensional geometry, that is to say with a geometry that deviates from a plate-shaped or cuboid-shaped geometry. In other words, by means of such manufacturing processes, the opposing outer sides of the cell separating element and in particular of the foam layer can be geometrically formed in such a way that they deviate from a plane. Such methods can therefore be advantageously used to form the cell separating element in an efficient and simple manner with a thickness that is greater in the first edge region than in the central region of the cell separating element.

The cell separating element is suitable and intended for arrangement between two battery cells of a battery module. These at least two battery cells of such a battery module are preferably prismatic battery cells. These have an essentially cuboid geometry. A battery module can comprise several such battery cells, in particular more than two such battery cells. A battery module can, for example, comprise a cell stack with multiple prismatic battery cells arranged next to one another in a stacking direction, which are arranged with their respective housing sides with the largest area facing one another. Such a cell separating element according to the invention or one of its embodiments can be arranged between each two battery cells arranged adjacent in the stacking direction. The first direction corresponds to the stacking direction based on the intended installation position in the battery module.

Furthermore, such a battery module shall also be considered as part of the invention. The battery cells can be formed as lithium-ion cells, for example. In addition, the battery cells can be geometrically shaped as already described above, that is to say to have a substantially cuboid geometry, wherein the edges or at least some of the edges of the cell housing of a respective battery cell can be rounded, in particular as described in more detail below.

The battery module for a battery, in particular a motor vehicle battery, can therefore comprise a cell stack which comprises multiple battery cells arranged next to one another in a stacking direction, which are designed as prismatic battery cells and each comprise a cell housing which has two opposite first cell housing sides which represent the cell housing sides with the largest area of a respective cell housing. The cell stack also has a first stack side that delimits the cell stack with respect to a first direction, wherein the first cell housing sides each have a housing edge region adjacent to the first stack side and wherein two battery cells arranged next to one another in the stack direction are arranged with respective first cell housing sides facing one another, so that between the respective housing edge regions of the first cell housing sides facing one another there is a respective intermediate space that defines a respective first gusset region between two battery cells arranged adjacent to one another.

The intermediate space between any two battery cells arranged adjacent to one another is widened in the gusset region between these battery cells compared to a central region of the intermediate space between the battery cells, wherein such a central region may comprise a center between the two battery cells with respect to the second direction. The second direction is preferably perpendicular to the above defined first direction. The cell housings therefore have a rounding in the housing edge region. This may apply analogously to further or all remaining housing edge regions of the respective first cell housing sides that border on other stack sides of the cell stack.

The polymeric material is preferably a thermoplastic soft component. In particular, it is a thermoplastic material with elastic properties. To produce the foam layer, this polymeric material can be foamed, in particular chemically foamed and/or physically foamed. In addition to the polymeric material, the foam layer can optionally also comprise other material components, such as fillers. However, the foam layer can also be made exclusively from the polymer material.

The two outer sides opposite each other with respect to the first direction preferably have a smooth or flat, unstructured surface. In relation to the intended installation position of the cell separating element between the two battery cells, the cell separating element with its two outer sides preferably lies flat, as intermediate space-free and form-fitting as possible on the first cell housing sides of these two battery cells facing the cell separating element. Furthermore, the cell separating element is preferably designed with regard to its dimensions such that such an outer side of the cell separating element covers at least the majority, for example at least 90 percent, or even the entirety, of the first cell housing side of the adjacent battery cell facing the outer side, in particular at least the entire flat surface of these first cell housing sides, and in particular the housing region facing the first edge region with the rounded edge of the battery cell.

The first edge region of the cell separating element comprises not only an outer side which delimits the cell separating element with respect to the second direction, in particular opposite to the second direction, which is also referred to below as the first edge side, but also a certain portion of the first cell separating element which adjoins this first edge side and extends in the second direction.

For the sake of simplicity and standardization, it is assumed below that the second direction is defined such that the first edge region delimits the cell separating element opposite to the second direction.

In addition, the cell separating element can comprise further edge regions, namely a second edge region which is opposite the first edge region with respect to the second direction, in particular in the second direction, and delimits the cell separating element in the second direction, as well as a third and fourth edge region which are opposite one another with respect to a third direction which is in particular perpendicular to the first and second directions, and which accordingly delimit the cell separating element on both sides with respect to this third direction. The remainder of the cell separating element can be defined, for example, as the central region of the cell separating element. This therefore comprises the center of the cell separating element at least in relation to the second direction and optionally also in relation to the third direction, as well as a region of the cell separating element starting from this center, which extends to the respective edge regions in relation to the second direction and optionally also in relation to the third direction.

The cell separating element can be designed with the widening described above only in the first edge region, while the thickness in the remaining edge regions of the cell separating element corresponds to the thickness of the cell separating element in the central region. It can also be provided that the thickness of the cell separating element in the second edge region is greater than the thickness of the cell separating element in the central region. Optionally, it can also be provided that the thickness of the cell separating element is greater in the third and/or fourth edge region than in the central region.

The two outer sides of the cell separating element are flat, i.e. lying in one plane, at least except for the first edge region, and optionally except for the second and/or third and/or fourth edge region.

The space between the two battery cells can also be divided into a central region and one or more, e.g. four, edge regions, which adjoin the central region, e.g. in and against the second direction and optionally also in and against the third direction. The central region of this intermediate space may represent the entire region of the intermediate space that borders on planar portions of the adjacent first cell housing sides of the two battery cells that delimit the intermediate space. With regard to the intended installation position of the cell separating element in such a battery module, i.e. between the two battery cells, it can further be provided that the cell separating element fills at least the entire central region of the intermediate space, as well as the edge region of the intermediate space adjacent to the central region of the intermediate space in the opposite direction to the second direction through the first edge region of the cell separating element. The cell separating element can be designed in such a way that it does not necessarily have to protrude into the remaining edge regions of the intermediate space, although this is still possible. In particular, the cell separating element can protrude into the edge region of the intermediate space adjoining the central region of the intermediate space in the second direction with the second edge region of the cell separating element and/or with its third and/or fourth edge region into the respective edge regions of the intermediate space adjoining the central region of the intermediate space in and against the third direction.

In addition to the foam layer, the cell separating element can also comprise further layers, in particular outer layers, as will be described in more detail later. However, in this case too, the increased thickness of the cell separating element in the first edge region is due to a greater thickness of the foam layer in the first edge region and not to an increased thickness of such outer layers.

Therefore, it represents a further very advantageous embodiment of the invention that a foam layer thickness of the foam layer in the central region of the foam layer is smaller than in the first edge region, in particular wherein the cell separating element has a second edge region which is opposite the first edge region in the second direction and delimits the cell separating element in the second direction, wherein the thickness of the cell separating element and the foam layer thickness of the foam layer are smaller in the central region than in the second edge region. The central region of the cell separating element can comprise the central region of the foam layer. The part of the foam layer which is located in the first edge region of the cell separating element can correspondingly be referred to as the first edge region of the foam layer. Furthermore, the regions of the cell separating element, as defined above, can also be defined analogously for the foam layer. The foam layer therefore advantageously also has a greater thickness in the first edge region than in the central region. The foam layer in particular can be easily formed as a 3D body, i.e. with non-flat and geometrically three-dimensionally shaped surfaces, by the manufacturing processes described above, namely by an extrusion process and/or foam injection molding process. The above-mentioned optional outer layers can then be easily applied, for example subsequently, to the outside of the foam layer produced in this way, in particular to the surfaces of the foam layer that delimit the foam layer in and against the first direction, or can already be formed on the surfaces of the foam layer during its manufacture, for example by means of corresponding inserts in the injection molding process.

Because the second edge region in particular is also widened, an even distribution of force can be provided between the two battery cells. In addition, this allows the same advantages to be achieved as already described with reference to the widening in the first edge region.

According to a further advantageous embodiment of the invention, the cell separating element is delimited with respect to the second direction by a first edge side which is part of the first edge region, wherein the first edge side is convexly curved in an uncompressed state of the cell separating element, in particular in a cross section perpendicular to a third direction which is perpendicular to the first and second directions. By means of such a convex curvature, it can advantageously be achieved that the cell separating element, in particular the foam layer, protrudes from the intermediate space between these two battery cells in the opposite direction to the second direction with respect to the intended installation position between the two battery cells. This mushroom-head-like design of the first edge side also makes it possible for only the elastically compressible foam layer portion of the cell separating element to protrude from the intermediate space, but not the optional outer layers of the cell separating element, which do not necessarily have to be made of an elastically compressible material. It would also be conceivable to extend only the foam layer with respect to the second direction, but not the outer layers, so that only the foam layer protrudes from the intermediate space against the second direction.

This protrusion of the foam layer has the great advantage that when the battery module is arranged on a carrier plate, for example a housing base or cooling base, it comes into contact with this base and is compressed in the process. This can provide an additional sealing effect compared to such a housing component. This in turn increases the protective effect of the neighboring cell in the event of thermal runaway of a battery cell.

According to a further advantageous embodiment of the invention, at least a part of the first edge side is provided by the foam layer and is designed as a pore-free, smooth outer skin. The first edge side, or at least the part of this first edge side which is provided by the plastic foam layer, should therefore not be designed to be open-pored. This can be achieved, for example, by a plastic foam layer manufactured using a foam injection molding process. A melt loaded with a blowing agent can be filled into the injection molding cavity to form the foam layer. After a predetermined cooling time, the finished component, namely the foam layer, can be removed from the injection mold. In such a manufacturing process, the foam layer does not have an open-pored outer skin, but rather a closed sprayed skin as the outer skin, i.e. without an open-cell region of the outer skin. The pores contained in the foam layer due to chemical foaming are therefore only located inside this foam layer. Thus, advantageously, at least the first edge side of the cell separating element can be provided as a smooth outer skin, as well as all other edge sides, for example those of the second and/or third and/or fourth edge regions defined above.

However, the foam layer could also be produced by a different process and the smooth outer skin could be achieved by a subsequent smoothing process, for example by partially heating the first edge side or the part of the edge side provided by the foam layer.

Such a pore-free, smooth outer skin has the advantage that the effective surface of this first edge side can be minimized. In the event of thermal runaway of a battery cell, this can more efficiently prevent gas from penetrating the foam structure of the foam layer and reduce the effective attack surface for such a gas.

According to a further advantageous embodiment of the invention, the central region of the foam layer in the second direction has a first partial region with a first pore density and a second partial region with a second pore density which is different from the first pore density. The foam layer can therefore advantageously be provided with different pore densities in different regions.

The pore density can be defined as the volume occupied by the pores of the foam layer in relation to the total volume of the foam layer in a defined partial region. A high pore density leads in particular to a low density of the foam layer in this region.

This has the great advantage that these different regions of the foam layer, namely the first partial region and the second partial region, can be designed with different hardness or with different elasticity properties. This allows better adaptation to different swelling properties of the adjacent battery cells. As they age, they typically swell more in a central region in relation to the second and third directions than in edge regions of the cells. This means that different counteracting forces can advantageously be applied to these different cell regions during swelling by means of the cell separating element. This has a positive effect on the service life of the battery cells.

In particular, it can be provided that the central region of the foam layer also comprises a third partial region with a third pore density and the second partial region is arranged in the second direction between the first partial region and the third partial region, wherein the second pore density is lower than the first and the third pore density. As a result, the cell separating element can be formed, for example, in the central region with respect to the second direction with a lower compressibility and/or elasticity than in the outer regions of the central region. As a result, a greater restoring force can be applied to the adjacent cells in the central region of the cell separating element in the event of expansion of the adjacent battery cells. In this way, the typical aging process of the battery cells can be counteracted locally by the cell separating element.

For the cell separating element, in particular for the foam layer, not only these two or three partial regions can be defined, but in principle any number of partial regions that can be designed with different pore densities, depending on the application and requirements. For example, the pore density of the foam layer may increase with increasing distance from the center of the foam layer with respect to the second and third directions outward, both with respect to the second direction and alternatively or additionally with respect to the third direction. This increase can also be step-wise and/or continuous.

Different pore densities can, for example, be easily provided within a foam injection molding process by using a locally different expansion stroke of the injection molding tool within such a foam injection molding process. In principle, an expansion stroke can be used in the foam injection molding process, according to which the mold halves of the injection molding tool providing the cavity are moved away from each other, thereby increasing the volume of the cavity. This leads to a stronger foaming reaction of the blowing agent-laden melt introduced into this cavity.

To produce different pore densities, at least one half of the injection molding tool can be made up of multiple parts and the multiple parts can be designed to be movable independently of one another. For this purpose, for example, a plunge edge tool with several, i.e. at least two, movable segments can be used, which allow a locally different expansion stroke. This makes it possible to generate an expansion stroke of varying strength in different regions, whereby the foaming reactions occur with varying intensities in different regions of the foam layer that has not yet solidified and is still in the cavity, so that different pore densities can be realized.

However, different pore densities can also be created using other manufacturing processes, for example in the case of an extrusion process.

According to a further advantageous embodiment of the invention, the cell separating element has two outer layers, which can also be called outer layers, which provide the respective outer sides and which are each formed on at least one of the following layers: a graphite layer, in particular in the form of a graphite foil, a fiber layer comprising glass fibers and/or ceramic fibers and/or mineral fibers, and an optional intumescent layer. The respective outer layers can also be formed with different ones of these layers and/or can each be multi-layered and comprise several of these layers. These outer layers or outer plies can advantageously provide protective layers for the foam layer. The outer layers mentioned are significantly more temperature-resistant and/or abrasion-resistant than the foam layer located between these outer layers. In the event of thermal runaway of a battery cell, the central foam layer can thus be protected thermally and/or against abrasion by these outer layers. The cell separating element can therefore be designed to be very temperature-stable and resistant, even in the event of thermal runaway of a battery cell.

In the case of an injection molding process for producing the cell separating element or at least the foam layer, it is also possible to form one or more of these outer layers by first placing and fixing a corresponding outer layer providing such an outer layer into the injection molding tool and then filling the injection molding cavity resulting between these outer layers with the blowing agent-laden melt. This allows the outer layers to be arranged on the foam layer in the same manufacturing process or manufacturing step as the formation of the foam layer. It is also conceivable to arrange these outer layers subsequently, i.e. after the foam layer has been manufactured, for example by gluing it or attaching it in some other way, for example by thermal bonding.

The outer layers act as fire protection layers. For this purpose, a film coated with a fire-retardant paint with a fire-retardant layer or something similar can also be used.

An intumescent layer, i.e. the intumescent layer, may comprise particles expanding under temperature. The intumescent layer can be provided in the form of a coating on the foam layer or as a coating on a separate carrier film, which in turn is arranged on the foam layer or on another of the said layers of the outer layer.

The fiber layer can, for example, be provided in the form of a textile semi-finished product, for example as fabrics, scrims, mats, and so on. These semi-finished fiber products can, for example, also optionally be provided with the intumescent layer as part of the outer layer, for example by being coated or provided with the intumescent layer on the outside, i.e. facing away from the foam layer, or on the inside, i.e. facing the foam layer.

The central layer, i.e. the foam layer, is in particular a flexible, elastically deformable foam which is connected to the outer layers in a flat manner and, as described, can have a compact, closed outer skin. With respect to the first direction, the cell separating element is preferably designed symmetrically with regard to its layer structure.

Furthermore, the invention also relates to a battery module having a cell separating element according to the invention or one of its embodiments.

According to a further advantageous embodiment, the battery module comprises two battery cells, wherein the cell separating element is arranged between the two battery cells and in particular directly adjacent to the two battery cells. The battery module or the battery cells can be designed as described above.

In this case, the two battery cells can each have a first cell side which delimits the respective battery cell opposite to the second direction, wherein a releasable cell degassing opening is arranged in a respective one of the first cell sides. It is precisely where the releasable cell degassing openings of the battery cells are located that a particularly good sealing and protective effect can be achieved by the design of the cell separating element described above. In particular, this can be achieved on the one hand by the widened design of the foam layer and thus of the cell separating element in the first edge region, and also by the optional preferred design of the cell separating element, in particular of the foam layer, such that it protrudes from the intermediate space between the two battery cells against the second direction in the non-compressed state with respect to the second direction. For example, the foam layer in the second direction in the non-compressed state can also be larger than each of the two battery cells in this second direction. However, this does not necessarily have to be the case, for example if the cell separating element is set back on the edge side with respect to the battery cells in the second direction.

Furthermore, the invention also relates to a battery for a motor vehicle which has a battery module according to the invention or one of its embodiments. The battery can be designed for example as a high-voltage battery. In addition, such a battery can also comprise several battery modules according to the invention and/or embodiments of the battery module according to the invention.

According to a further advantageous embodiment, the battery comprises a housing wall which is arranged next to the battery module with respect to the second direction, in particular is arranged next to the battery module opposite to the second direction, wherein the cell separating element rests against the housing wall with its first edge side and is at least partially compressed in the second direction, in particular in the first edge region. This advantageously allows the cell separating element to have a sealing effect with respect to the housing wall, which in turn benefits fire protection.

Furthermore, the invention also comprises a motor vehicle having a battery according to the invention or one of its embodiments.

The motor vehicle according to the invention is preferably designed as an automobile, in particular as a passenger car or truck, or as a passenger bus or motorcycle.

The invention also relates to a method for producing a cell separating element for arrangement between two battery cells of a battery module, wherein the cell separating element is formed with at least one elastically compressible foam layer comprising a polymeric material, wherein the cell separating element is formed with two outer sides opposite one another with respect to a first direction, the spacing of which in the first direction defines a thickness of the cell separating element, and wherein the cell separating element, when finished, has a first edge region which delimits the cell separating element with respect to a first direction. The cell separating element is manufactured in such a way that the thickness of the cell separating element is greater in the first edge region than in a central region of the cell separating element.

The advantages described in relation to the cell separating element according to the invention and its embodiments apply in the same way to the method, the battery module and the battery according to the invention.

According to a further advantageous embodiment of the invention, the foam layer is produced by means of an injection molding process or extrusion process, in particular such that a foam layer thickness of the foam layer is greater in the central region of the foam layer than in the first edge region.

The use of an injection molding process, in particular a foam injection molding process and/or extrusion process, is particularly advantageous for realizing the above-mentioned properties of the cell separating element and in particular of the foam layer.

The invention also includes developments of the battery module according to the invention, of the battery according to the invention and the method according to the invention, which have features as already described in connection with the developments of the cell separating element according to the invention. For this reason, the corresponding developments of the battery module according to the invention, of the battery according to the invention and of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic and perspective cross-sectional representation of a part of a battery;

FIG. 2 shows a schematic detailed view of the battery from FIG. 1;

FIG. 3 shows a schematic cross-sectional representation of a part of a battery according to an exemplary embodiment of the invention.

FIG. 4 shows a schematic cross-sectional representation of a part of a battery according to another exemplary embodiment of the invention;

FIG. 5 shows a schematic cross-sectional representation of a cell separating element according to an exemplary embodiment of the invention; and

FIG. 6 shows a perspective representation of the cell separating element from FIG. 5 according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

The coordinate systems shown in the figures can be Cartesian coordinate systems. The x-direction of the coordinate system shown can correspond to the previously defined first direction, the z-direction shown to the previously defined second direction, and the y-direction shown to the previously defined third direction.

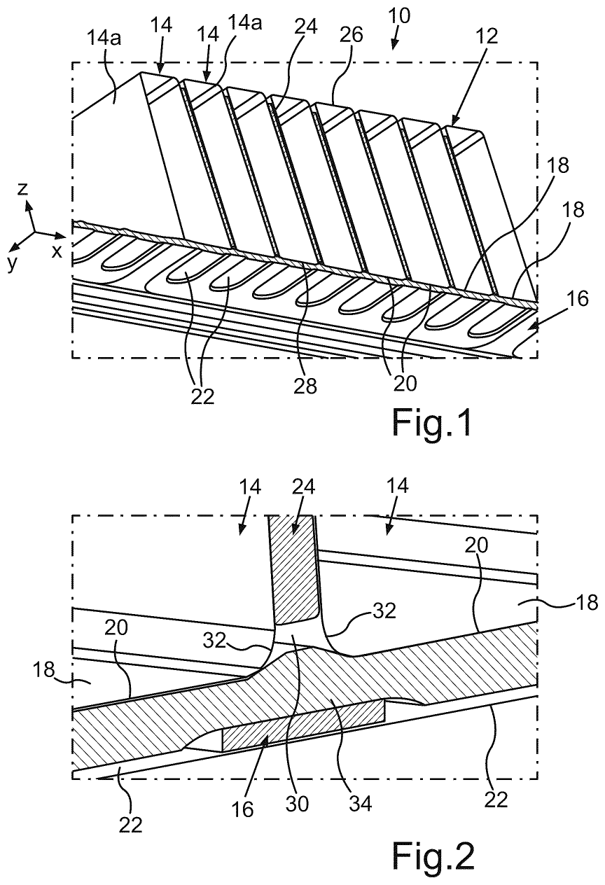

FIG. 1 shows a schematic and perspective cross-sectional representation of a part of a battery according to an example not belonging to the invention. The battery 10 comprises a battery module 12, which in turn comprises several battery cells 14 arranged next to one another in a stacking direction x, of which only their cell housings 14a are shown. Of the battery cells 14 and their cell housings 14a, in this case only some are provided with a reference numeral for reasons of clarity. Furthermore, the battery 10 comprises a housing component 16, for example a housing base 16. The housing base 16 can be designed as a cooling base. Each battery cell 24 has a releasable cell degassing opening 20 on its cell housing underside 18, which can be designed, for example, as a predetermined breaking point or bursting membrane in the housing underside, and which can also be referred to as a cell vent 20. In this example, the housing base 16 also comprises predetermined passage points 22 through which the gas escaping from a thermally runaway battery cell 14, in particular the gas escaping from the corresponding releasable cell degassing opening 20, can pass and be discharged via a degassing channel. The component 16 can be designed as an aluminum sheet metal with a clearance 22 for the cell vents 20. Through this clearance 22, the target passage regions 22 are provided. A cover film can also be arranged over these through openings 22 in the aluminum sheet.

Between each two battery cells 14 arranged next to one another in the stacking direction x there is a cell separating element 24 according to an example not belonging to the invention. However, with the exception of the design of these cell separating elements 24, all other components of this battery 10 can optionally also be implemented within the framework of a battery according to the invention or one of its embodiments.

Such cell separating elements 24 are usually designed as two-dimensional elements, for example as flat plates. These should ideally fulfill various functions, for example ensure good thermal insulation between the cells 14 through low thermal conductivity, and in the event of a malfunction, such as thermal runaway of a cell 14, provide fire protection and thermal insulation to the neighboring cell, as well as being able to absorb mechanical forces in conventional operation for swelling compensation.

Such swelling forces hardly occur in an edge region of the cells 14. In particular, cell swelling of prismatic battery cells 14 usually results in a bulging of these cells, that is to say a convex swelling thereof in the central region of their cell walls with the largest surface area. In order to be able to better compensate for height tolerances of the cells 14 and to make it possible to arrange such a battery module 12 as flush as possible on the housing component 16, the cell separating elements 24 are often designed to be shorter in height in the z-direction than the battery cells 14 and in particular do not reach to the top 26 and the bottom 28 of the battery module 12.

This is illustrated again in detail in FIG. 2. What can be seen here is a section of the battery 10 shown in FIG. 1, which shows a part of two cells 14 with the cell separating element 24 located therebetween. Below the cell separating element 24 there is a free space 30, that is, a free volume, at the transition between the cell separating element 24 and the radius of the cells 14, that is, the region of the cells 14 with the rounded edges 32.

If gas escapes from one of the releasable cell degassing openings 20, it should be prevented, if possible, that this gas can come into contact with the neighboring cell. To make this possible, the region between the battery cells 14 should be sealed as well as possible. This is attempted, for example, by a tolerance compensation element 34 running between the cells 14 and the component 16. This can be made of foam or something similar.

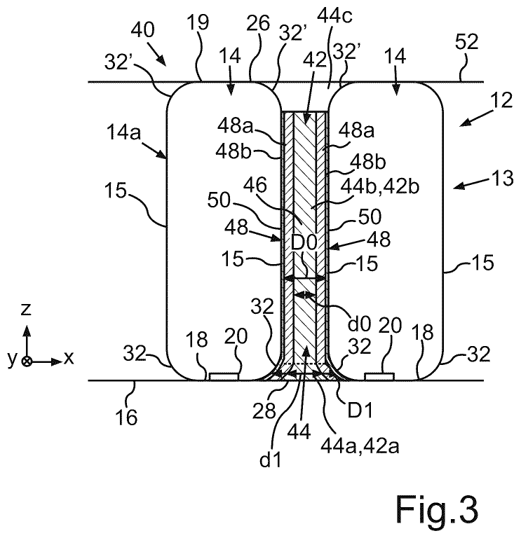

FIG. 3 shows a schematic cross-sectional illustration of a part of a battery 40 according to an exemplary embodiment of the invention. This can in particular be designed as before, except for the design of the cell separating element 42 or several such cell separating elements 42 explained in more detail below. However, other components of this battery 40 can optionally be designed differently than previously described.

The battery 40 comprises a battery module 12, which in turn has a cell stack 13 with multiple battery cells, in particular prismatic battery cells 14, arranged next to one another in a stacking direction x. The battery cells 14 have a cell housing 14a. This cell housing 14a comprises two first cell housing sides 15 which are opposite one another with respect to the x-direction and which in particular represent the housing sides of the cell housing 14a having the largest area. The cells 14 face each other with their largest area sides 15. In addition, the cell housing 14a comprises a lower side 18 in which a releasable cell degassing opening 20 is provided. This can be designed as described above. The lower side 18 is opposite an upper side 19 of the cell housing 14a. The x-direction of the coordinate system shown can correspond to the previously defined first direction, the z-direction shown to the previously defined second direction, and the y-direction shown to the previously defined third direction.

The cell housings 14a are designed such that the transition between the first sides 15 and the respective lower sides 18 or upper sides 19 is rounded. In other words, the cells 14 have rounded edges 32, 32′. The rounded edges 32 border on the lower side 18 and the rounded edges 32′ border on the upper sides 19 of the respective cell housings 14a.

Between the cells 14 there is a intermediate space 44 in which the cell separating element 42 is arranged. The intermediate space 44 can be divided into at least three regions, namely a first region 44a, a second region 44b and a third region 44c, wherein the second region 44b represents a central region which is arranged between the first and third regions 44a, 44c with respect to the z-direction. The first and third regions 44a, 44c respectively adjoin the top side 26 and bottom side 28 of the module 12 and the cell stack 13. The first and third regions 44a, 44c represent those regions of the intermediate space 44 which are arranged between the rounded edges 32, 32′ of the cells 14. The region 44b is arranged between the flat regions of the first housing sides 15 of the cells 14.

The cell separating element 42 can also be divided into different regions, namely at least one central region 42b, which is arranged in the central region 44b of the intermediate space 44, and at least one first edge region 42a, which is arranged in the first region 44a of the intermediate space 44.

The cell separating element 42 further comprises a central layer 46, which is a foam layer 46 made of a polymeric material, in particular a thermoplastic soft component or at least comprising such a thermoplastic soft component. In addition, the cell separating element 42 comprises two outer layers 48, which in this example are each constructed in multiple layers, but can also be constructed in only one layer. Each of these outer layers 48 comprises, for example, a fire protection layer 48a. This can be, for example, a graphite layer or a fiber layer with glass fibers and/or ceramic fibers or mineral fibers, for example in the form of a fabric or similar, a foil with a fire protection coating, for example a fire protection paint, or similar. Furthermore, in this example, the outer layer 48 comprises a further layer 48b, which represents an intumescent layer. The intumescent layer 48b may be disposed between the foam layer 46 and the fire protection layer 48a or the fire protection layer 48a may be disposed between the foam layer 46 and the intumescent layer 48b. All layers, i.e. the outer layers 48 and the foam layer 46, extend, for example, over the entire cell separating element 42 with respect to the z-direction, and in particular also with respect to the y-direction.

The outer layers 48 provide respective outer sides 50 which directly adjoin the first housing sides 15 of the adjacent cells 14 and lie flat against them.

The cell separating element 42 is now advantageously designed such that its thickness DO in the central region 42b is smaller than a thickness D1 in the first edge region 42a. In particular, this is due to the fact that the foam layer thickness d0 of the foam layer 46 in the central region 42b is smaller than the foam layer thickness d1 in the first edge region 42a.

The battery 40 also comprises a plate-shaped housing component 16, for example a housing base 16 of a battery housing. The housing base 16 can, for example, be designed as a cooling base with integrated cooling channels. In particular, the housing base 16 can be designed as already described for FIG. 1 and FIG. 2. This may also include target passage points 22 which are not explicitly shown here. In this example, the battery 40 also comprises a housing cover 52.

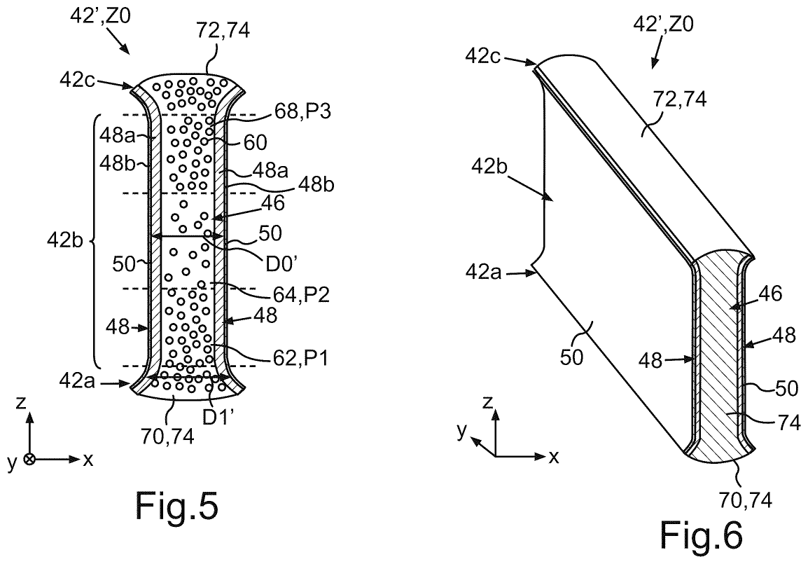

FIG. 3 further shows the battery 40 in a state in which the cell separating element 42, in particular its foam layer 46, is at least partially compressed, both with respect to the illustrated x-direction and with respect to the illustrated z-direction. By loading the cell stack 13, the cell separating element 42 located between the cells 14 and in particular its foam layer 46 is thus compressed with respect to the x-direction. In the uncompressed state, the cell separating element 42 and in particular the foam layer 46 have slightly larger dimensions with respect to the x-direction than in this compressed state. In addition, the cell separating element 42, in particular its foam layer 46, can be designed such that it protrudes from the underside of the intermediate space 44 in an uncompressed state with respect to the z-direction, as can be clearly seen in FIG. 5, for example. By means of such a protrusion against the z-direction, it can advantageously be achieved that the cell separating element 42, in the installed state, is flush with the housing component 16 or rests against it in a sealing manner. The widening in the first edge region 42a also results in the intermediate space 44 in the first region 44a being completely filled by the cell separating element 42. This advantageously enables an efficient “sealing” of the two cells 14 from each other. This design of the cell separating element 42 therefore makes it more difficult for a gas escaping from one of the cell vents 20 to reach the neighboring cell 14. The cell separating element 42 therefore has a form-fitting connection in the transition to the radius of the cells 14, i.e. in the region of their rounded edges 32, as well as to the component 16 underneath and thus seals particularly well to the cells 14 and to the component 16.

Furthermore, the cell separating element 42 can be designed in this way not only in its first edge region 42a, but also in other edge regions.

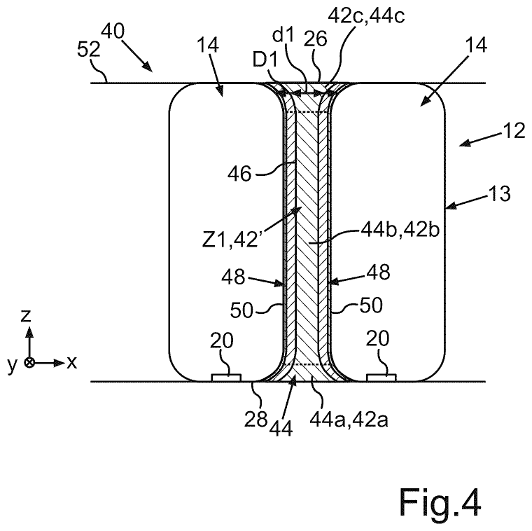

FIG. 4 shows a schematic representation of a battery 40 with a cell separating element 42′ according to a further exemplary embodiment of the invention. The battery 40 as well as the cell separating element 42′ can be designed as described with reference to FIG. 3, except for the differences described below. In this example, the cell separating element 42′ is arranged in the third region 44c of the intermediate space 44. This second edge region 42c can be designed to be mirror-symmetrical to the first edge region 42a. This region is also wider than the central region 42b. The cell separating element or the foam layer 46 can have a respective thickness D1, d1 in this region, which corresponds to the corresponding thicknesses D1, d1 in the first edge region 42a. These thicknesses D1, d1 do not have to be constant in the respective edge regions 42a, 42c, but, as is also preferred, increase with increasing distance from the central region 42b, in particular continuously and not abruptly. This allows for optimal adaptation to the cell geometry.

Optionally, the cell separating element 42′ can be formed in and against the y-direction with corresponding third and fourth edge regions, which are also widened relative to the central region 42b and/or protrude beyond the intermediate space 44 between the cells 14 in the uncompressed state. However, the cell separating element 42 can also be designed such that it has a widening only in the two edge regions 42a, 42c or in the first edge region 42a, in the third and fourth edge regions defined above, but not in the second edge region 42c.

FIG. 5 shows a schematic cross-sectional view of such a cell separating element 42′ according to an exemplary embodiment of the invention and FIG. 6 shows the cell separating element from FIG. 5 again in a perspective view. The cell separating element 42′ can be designed as previously described. The cell separating element 42′ is shown here in an uncompressed state Z0, i.e. as it is present when it is not yet installed in the battery module 12 or in the battery 40. This can have a corresponding thickness D0′, D1′ both in the central region 42b and in the first and second edge regions 42a, 42c, which are each greater than the corresponding thicknesses D0, D1 in the compressed and thus installed state, as shown for example in FIG. 4. The compressed state is also denoted by Z1 in FIG. 4.

In addition, the pores 60 enclosed by the foam layer 46 are illustrated in FIG. 5 as an example. According to a further embodiment, the cell separating element 42′ can also be designed such that it has different pore densities in different regions. In the present example, the central region 42b is subdivided into three partial regions 62, 64, 68, wherein each partial region 62, 64, 68 has an associated pore density P1, P2, P3. A very advantageous embodiment of the invention provides that the pore density P2 in the central region 64 is lower than in the other two regions 62, 68. The pore densities in the outer regions 62, 68 can in particular be the same, but this does not necessarily have to be the case. Furthermore, the pore density of the foam layer 46 does not have to change step by step, but can also change continuously or in significantly more steps starting from the center to the respective edge regions 42a, 42c, and optionally also in the same way with respect to the y-direction.

Pores 60 are also located in the edge regions 42a, 42c of the foam layer 46. These can also have a different pore density or, for example, the same as in the outer regions 62, 68.

Due to such a locally different pore density P1, P2, P3, the cell separating element 42′ is particularly well adapted to the swelling behavior of the prismatic battery cells 14, which typically bulge more in the central region with respect to the x- and y-direction of their largest area sides 15 than in edge regions.

In addition, the excessive formation of the foam material, i.e. the foam layer 46 with respect to the z-direction, can also be clearly seen in FIG. 5. The cell separating element 42′ thus has a first edge side 70 which delimits the cell separating element 42′ against the Z direction. In the illustrated uncompressed state Z0, this edge side is convexly curved outwards, especially in a cross-section perpendicular to the y-direction. The cell separating element 42′ also has a second edge side 72, which delimits the cell separating element 42′ in the z-direction and which can also be convexly curved.

Furthermore, it can be provided that these edge sides 70, 72 are each designed as a closed-pore, smooth outer skin 74. This can be provided in a simple manner, for example, by producing at least the foam layer 46 in a foam injection molding process. In the course of such a foam injection molding process, the outer layers 48 can also be easily joined to the foam layer 46, in particular in the course of the same manufacturing step. A subsequent addition of the outer layers 48 is also conceivable.

Overall, the examples show how the invention allows the provision of a process and an embodiment of cell separating elements for high-voltage batteries. Such a cell separating element is intended for installation in a high-voltage module or vehicle. In particular, the cell separating element can be arranged in a cell stack, i.e. in a cell stack with multiple battery cells, as a spacer between the surfaces of the prismatic battery cells. The cell separating element can advantageously have a defined layer structure with certain materials. A symmetrical structure with at least three layers has proven to be particularly advantageous. For example, outer layers can be provided by at least one layer of a non-combustible material or materials, for example comprising glass, ceramic or mineral fibers, for example in the form of textile semi-finished products such as fabrics, scrims, mats, etc. The semi-finished fiber products or the outer layer can optionally be provided with an intumescent layer. The intumescent layer can be applied on the textile and/or inside the textile. Alternatively or additionally, a graphite foil can also be used as an outer layer. The central layer is made, for example, of a flexible, elastic, deformable foam, previously also referred to as a foam layer, and can be designed with the outer layers and a compact, closed outer skin. The foam layer is particularly designed as plastic foam.

The cell separating element can be designed to be predominantly planar, but at least in a transition region to a radius of the cell cups with increasing geometry adapted to the geometry of the cell cup. The widening of the geometry is preferably towards the side on which the vent of the cell, i.e. the releasable cell degassing opening, is located, in this example downwards. Furthermore, the cell separating element can be designed to be exceedingly high, so that the foam body, i.e. the foam layer, is compressed in this region by the installation against adjacent parts, such as the plate-shaped housing component. In the region of the free foam edges, the cell separating element has a closed skin, i.e. it is not open-pored. The most suitable manufacturing process is the use of an injection molding process. For this purpose, the outer layers can first be assembled, inserted into the injection molding tool and fixed in the tool. The injection molding cavity can then be closed to an intermediate space of, for example, approx. 1.3 mm to 4 mm. This is followed by an injection of the blowing agent-laden melt, which fills the intermediate space between the outer layers of the cell separating element to be manufactured. Optionally, an expansion stroke of the tool can also be carried out at this stage to adjust the wall thickness. This expansion stroke can be of varying strength in different regions of the cell separating element in order to achieve different pore densities. This is followed by a cooling period and, once this has elapsed, the finished component, i.e. the cell separating element, is removed. As an alternative, the outer layers can also be subsequently applied to the foam layer produced in this way, i.e. they do not have to be initially inserted into the injection molding tool. Alternatively, the cell separating element and/or at least the foam layer can be manufactured by extrusion. Above all, the injection molding process automatically results in a closed injection skin on the outside of the foam layer. In this case, no open-cell region is created on the outside due to the injection molding process described. Ultimately, this makes it possible to provide a cell separating element that is predominantly planar, except for the transition region to the radius of the cell cups, which has an increasingly more adapted geometry to the geometry of the cell cup. In the uninstalled expanded state of the cell separating element, the foam layer is expanded accordingly and the thickness is greater than after stacking. The foam geometry can also be excessively designed upwards and/or downwards. This protrusion is compressed in the installation position.

1. Cell separating element for arrangement between two battery cells of a battery module, comprising:
at least one elastically compressible foam layer comprising a polymeric material,
two outer sides opposite one another with respect to a first direction, the spacing of which in the first direction defines a thickness of the cell separating element, and
a first edge region which delimits the cell separating element with respect to a second direction,
wherein the thickness of the cell separating element is greater in the first edge region than in a central region of the cell separating element.

2. The cell separating element according to claim 1, wherein a foam layer thickness of the foam layer in the central region of the foam layer is smaller than in the first edge region, wherein the cell separating element has a second edge region which is opposite the first edge region in the second direction and delimits the cell separating element in the second direction, wherein the thickness of the cell separating element and the foam layer thickness of the foam layer in the central region are smaller than in the second edge region.

3. The cell separating element according to claim 1, wherein the cell separating element is delimited with respect to the second direction by a first edge side which is part of the first edge region, wherein the first edge side is convexly curved in an uncompressed state of the cell separating element, in a cross-section perpendicular to a third direction which is perpendicular to the first and second directions.

4. The cell separating element according to claim 1, wherein at least a part of the first edge side is provided by the foam layer and is designed as a pore-free, smooth outer skin.

5. The cell separating element according to claim 1, wherein the central region of the foam layer in the second direction has a first partial region with a first pore density and a second partial region with a second pore density which is different from the first pore density, wherein the central region of the foam layer comprises a third partial region with a third pore density and the second partial region is arranged in the second direction between the first partial region and the third partial region, wherein the second pore density is lower than the first and third pore densities in each case.

6. The cell separating element according to claim 1, wherein the cell separating element has two outer layers providing the respective outer sides, each of which is formed as at least one of the following layers:
a graphite layer in the form of a graphite foil;
a fiber layer comprising glass fibers and/or ceramic fibers and/or mineral fibers; and
an intumescent layer.

7. A battery module with a cell separating element according to claim 1, comprising:
two battery cells, wherein the cell separating element is arranged between the two battery cells directly adjacent to the two battery cells, wherein the two battery cells each have a first cell side which delimits the respective battery cell opposite to the second direction, wherein a releasable cell degassing opening is arranged in a respective one of the first cell sides.

8. The battery for a motor vehicle with a battery module according to claim 7, wherein the battery further comprises a housing wall which is arranged next to the battery module with respect to the second direction, wherein the cell separating element rests with its first edge side on the housing wall and is at least partially compressed in the second direction, in the first edge region.

9. A method for producing a cell separating element for arrangement between two battery cells of a battery module,
wherein the cell separating element is formed with at least one elastically compressible foam layer comprising a polymeric material,
wherein the cell separating element is formed with two outer sides opposite one another with respect to a first direction, the spacing of which in the first direction defines a thickness of the cell separating element, and
wherein the cell separating element in the manufactured state has a first edge region which delimits the cell separating element with respect to a second direction,
wherein the cell separating element is manufactured such that the thickness of the cell separating element is greater in the first edge region than in a central region of the cell separating element.

10. The method according to claim 9, wherein the foam layer is produced by an injection molding process or extrusion process, so that a foam layer thickness of the foam layer is greater in the central region of the foam layer than in the first edge region.

11. The cell separating element according to claim 2, wherein the cell separating element is delimited with respect to the second direction by a first edge side which is part of the first edge region, wherein the first edge side is convexly curved in an uncompressed state of the cell separating element, in a cross-section perpendicular to a third direction which is perpendicular to the first and second directions.

12. The cell separating element according to claim 2, wherein at least a part of the first edge side is provided by the foam layer and is designed as a pore-free, smooth outer skin.

13. The cell separating element according to claim 3, wherein at least a part of the first edge side is provided by the foam layer and is designed as a pore-free, smooth outer skin.

14. The cell separating element according to claim 2, wherein the central region of the foam layer in the second direction has a first partial region with a first pore density and a second partial region with a second pore density which is different from the first pore density, wherein the central region of the foam layer comprises a third partial region with a third pore density and the second partial region is arranged in the second direction between the first partial region and the third partial region, wherein the second pore density is lower than the first and third pore densities in each case.

15. The cell separating element according to claim 3, wherein the central region of the foam layer in the second direction has a first partial region with a first pore density and a second partial region with a second pore density which is different from the first pore density, wherein the central region of the foam layer comprises a third partial region with a third pore density and the second partial region is arranged in the second direction between the first partial region and the third partial region, wherein the second pore density is lower than the first and third pore densities in each case.

16. The cell separating element according to claim 4, wherein the central region of the foam layer in the second direction has a first partial region with a first pore density and a second partial region with a second pore density which is different from the first pore density, wherein the central region of the foam layer comprises a third partial region with a third pore density and the second partial region is arranged in the second direction between the first partial region and the third partial region, wherein the second pore density is lower than the first and third pore densities in each case.

17. The cell separating element according to claim 2, wherein the cell separating element has two outer layers providing the respective outer sides, each of which is formed as at least one of the following layers:
a graphite layer in the form of a graphite foil;
a fiber layer comprising glass fibers and/or ceramic fibers and/or mineral fibers; and
an intumescent layer.

18. The cell separating element according to claim 3, wherein the cell separating element has two outer layers providing the respective outer sides, each of which is formed as at least one of the following layers:
a graphite layer in the form of a graphite foil;
a fiber layer comprising glass fibers and/or ceramic fibers and/or mineral fibers; and
an intumescent layer.

19. The cell separating element according to claim 4, wherein the cell separating element has two outer layers providing the respective outer sides, each of which is formed as at least one of the following layers:
a graphite layer in the form of a graphite foil;
a fiber layer comprising glass fibers and/or ceramic fibers and/or mineral fibers; and
an intumescent layer.

20. The cell separating element according to claim 5, wherein the cell separating element has two outer layers providing the respective outer sides, each of which is formed as at least one of the following layers:
a graphite layer in the form of a graphite foil;
a fiber layer comprising glass fibers and/or ceramic fibers and/or mineral fibers; and
an intumescent layer.
